(19) United States
(12) Patent Application Publication
(10) Pub. No.: US 2019/0163762 A1
(43) Pub. Date: May 30, 2019

(54) REFLOW OF USER INTERFACE ELEMENTS

(71) Applicant: Adobe Inc., San Jose, CA (US)

(72) Inventors: Alexandru-Daniel Mirea, Staufen im Breisgau (DE); Oscar Bolanos, Ecublens (CH); Christanto Leonardo, Basel (CH)

(73) Assignee: Adobe Inc., San Jose, CA (US)

(21) Appl. No.: 15/827,255

(22) Filed: Nov. 30, 2017

(51) Int. Cl. G06F 17/30; G06F 17/22; G06F 9/44

(52) U.S. Cl. CPC G06F 17/3089; G06F 9/4443; G06F 17/2247

(57) ABSTRACT

User interface (UI) reflow extension techniques are disclosed which allow a UI designer to specify predefined configurations of a UI for a reflow process to control reflow of the UI. In some examples, a method may include registering one or more component states of each component included in a UI, registering multiple UI configurations of the UI, and determining a respective width of each registered UI configuration of the multiple registered UI configurations. The method may also include, responsive to a UI refresh event, identifying a widest registered UI configuration that best fits within a display container, and refreshing the UI by rendering the identified widest UI configuration that best fits within the display container.

### FIELD OF THE DISCLOSURE

This disclosure relates generally to user interfaces, and more particularly, to reflow of user interface elements.

### BACKGROUND

A webpage is a document that is displayable by a browser or other suitable application for retrieving, presenting, and traversing webpages. A webpage may be written using a suitable markup language, such as Hyper Text Markup Language (HTML), and may be viewed as containing one or more component. Each component in the webpage can include one or more elements, such as User Interface (UI) elements. Most browsers today provide a graphical user interface (GUI) with which to display retrieved webpages. When a user opens a webpage using a browser, the browser renders the webpage, and the webpage is displayed inside a subarea of a browser window called a “viewport.”

### BRIEF DESCRIPTION OF THE DRAWINGS

The accompanying drawings are not intended to be drawn to scale. In the drawings, each identical or nearly identical component that is illustrated in various figures is represented by a like numeral, as will be appreciated when read in context.

FIG. 1 is a diagram illustrating an example user interface (UI) reflow extension framework, in accordance with at least some embodiments described herein.

FIG. 2 is a diagram illustrating multiple configurations of an example UI specified by component states included in each configuration of the UI, in accordance with at least some embodiments described herein.

FIG. 3 is a diagram illustrating two example UI configurations and corresponding rendering of the UI configurations, in accordance with at least some embodiments described herein.

FIG. 4 is another diagram illustrating two example UI configurations and corresponding rendering of the UI configurations, in accordance with at least some embodiments described herein.

FIG. 5 is a flow diagram illustrating an example process to render and refresh a UI, in accordance with at least some embodiments described herein.

FIG. 6 is a flow diagram illustrating an example process to render and refresh a webpage, in accordance with at least some embodiments described herein.

FIG. 7 is a flow diagram illustrating an example process to determine widths of registered webpage configurations, in accordance with at least some embodiments described herein.

FIG. 8 is a flow diagram illustrating an example process to perform a change webpage configuration, in accordance with at least some embodiments described herein.

FIG. 9 illustrates selected components of an example computing system that may be used to perform any of the techniques as variously described in the present disclosure, in accordance with at least some embodiments described herein.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

### DETAILED DESCRIPTION

A User Interface (UI) may be viewed as containing one or more components (interchangeably referred to herein as “components” or “UI components”), such as wizards (e.g., set-up assistant), icons, task bars, image viewers, video players, and text windows, to name a few examples, which may further include one or more UI elements. When a UI agent application executing on a computing system renders a UI on a display screen of the computing system, the visible components of the UI are typically displayed inside, and consume a portion of a display container (e.g., display window, such as a viewport). The visibility and appearance of the components are typically determined by the size of the display container. A user may resize the display container using a suitable UI device, such as a mouse, a keyboard, a touch screen, or the like. Additionally or alternatively, the display container may be resized by other applications that may be executing on the computing system, assuming that the necessary permissions have been granted to such other applications. Resizing the display container can cause the UI agent application to refresh (e.g., re-render) the display of the UI in the resized display container. Additionally, the UI agent application can periodically refresh the display of the UI in the display container without waiting for the display container to be resized. Refreshing the display of the UI typically includes a reflow of the UI, which includes re-computing the layout of the UI (e.g., re-computing the positions and geometries of the components included in the UI for the purpose of refreshing part or all of the UI). However, there are a number of issues that can arise with such refreshing.

For instance, refreshing the display of the UI in a resized display container, such as a smaller display container, may cause the visible components or elements of the components of the UI to overflow (e.g., to stack one under another) or otherwise change to an unexpected visible state. As the components may and typically include variable elements (e.g., variable content), the overflow or change in the visible state of the components can occur at any display container size depending on the components and the elements included in the components of the UI. Moreover, it may not be possible to predict a display container size at which the components may overflow or change visible states. For instance, and taking an example of a wizard component, such as a set-up assistant that includes an element depicting a series of well-defined steps or tasks, an overflow or a change in visible state of the wizard component can unexpectedly occur at different display container sizes depending on the number of steps or tasks in the wizard.

Similar problems arise in the context of the UI being a webpage. In more detail, the webpage may contain one or more components (webpage components), and each component may include one or more elements. When a browser executing on a computing system renders the webpage, the visible components of the webpage may be displayed inside, and consume a portion of a browser viewport. The visibility and appearance of the components may be determined by the size of the viewport. A resize of the viewport can cause the browser to refresh the display of the webpage in the resized viewport. The browser can also periodically refresh the display of the webpage in the viewport without waiting for the viewport to be resized. A refresh of the display of the webpage can trigger a browser reflow, which computes the layout of the webpage. That is, a browser reflow re-computes the positions and geometries of the components in the webpage for the purpose of re-rendering part or all of the webpage (e.g., components in the webpage). Reflowing a single component in the webpage may cause (e.g., trigger) reflows on the parent components and children components. However, the browser reflow may cause the visible component or elements of the components of the webpage to overflow (e.g., to stack one under another) or otherwise change to an unexpected visible state.

To this end, techniques are disclosed herein for a UI reflow extension framework that allows a UI designer (or UI developer) to control reflow of a UI. The framework allows a UI designer to specify a predefined configuration of a UI for the reflow process that is performed as part of a refresh of a display of the UI. For example, a UI designer can create (e.g., code) multiple UI configurations of a UI, and specify the “breakpoints” in the width of the display container at which each UI configuration of the UI is to be displayed. The width of a display container can be measured, for instance, in pixels, such as the number of pixels that fit in a single horizontal line of pixels that spans the lateral width of the display container, according to some embodiments. However, as will be appreciated in light of this disclosure, other embodiments may use any other suitable unit of measure (e.g., pixels, pixel groups, millimeters, inches, bits, binary words, or some unit of measure from which the lateral width of a given display container can be either directly or indirectly determined). A breakpoint correlates to a specific width of the display container at which a specific UI configuration is displayed. The specific width of the display container at which a specific UI configuration is displayed is determined by the width of the UI configuration, which can be determined, for instance, by the total of the widths of the components included in the UI configuration. Accordingly, the UI designer is able to specify the breakpoints by specifying the components that are included in each UI configuration. In operation, a display of the UI switches (changes) from one UI configuration created by the UI designer to another UI configuration created by the UI designer based on the total of the widths of the components included in each of the UI configurations and the width of the display container. The total of the widths of the components included in each UI configuration, without regard to the actual layout of the components when actually displayed, is used to determine the respective breakpoints in the widths of the display container at which each of the UI configurations is displayed in the display container, according to some example embodiments.

One result of using the total of the widths of the components included in a UI configuration, without regard to the actual layout of the components when displayed, is that, with the exception of the smallest (least wide) UI configuration, the components included in the UI configuration will not overflow or change to a visible state that is unexpected by the UI designer as a result of the reflow of the UI. That is, except for the least wide UI configuration, the display of the UI will switch from displaying one UI configuration to a smaller UI configuration when the width of the display container becomes smaller and before the components in the displayed UI configuration overflow or change to an unexpected visual state as a result of the width of the display container becoming smaller. Conversely, any increase in the width of the display container causes the display of the UI to either change to a wider UI configuration, if a wider UI configuration is available and the wider UI configuration fits in the display container, or continue the display of the UI configuration that is currently being displayed in a “larger” visible state as a result of the UI reflow. As the display container is made wider, the larger visible state is not a state in which the components in the displayed UI configuration overflow, or a state in which the components are in a visual state that is unexpected, for example, by the UI designer (or other viewer). Accordingly, the UI designer is able to control a reflow of a UI by determining the “breakpoints” in the width of a display container that is displaying the UI at which a switch in the display of the UI from one UI configuration to another UI configuration is to occur. Additionally, the UI designer is able to specify the UI configurations that are to be used in the reflow of the UI.

In some embodiments, the framework includes a UI reflow extension for use by a UI designer to control reflows of the UI. The control of the reflows is achieved by the UI reflow extension as part of a refresh of a display of a UI and, more specifically, a refresh of a display of a UI configuration. That is, the UI reflow extension executes as part of each UI display refresh process to control the reflow of the UI. In some embodiments, a UI designer can create a UI that includes one or more components. In addition, according to some such embodiments, the UI designer can create, for each component, one or more states (interchangeably referred to herein as “component states”), define multiple configurations of the UI (interchangeably referred to herein as “UI configurations”) by specifying the state of each component included in each UI configuration, include code to register the UI configurations of the multiple UI configurations that are to be used in rendering the UI with the UI reflow extension, and include the UI reflow extension as part of the UI to be executed contemporaneously with the rendering of the UI. Subsequently, when a UI agent application first renders the UI (e.g., an initial or default configuration of the UI) in a display container, the UI reflow extension included with the UI can start executing. In some embodiments, the UI reflow extension processes a registration of the component states created for the UI, and the registration of the multiple UI configurations. That is, the code included as part of the UI to register the UI configurations may execute to register the UI configurations with the UI reflow extension. Registering the UI configurations with the UI reflow extension includes the registered UI configurations to the UI reflow extension process for use in controlling the reflow of the UI using the registered UI configurations. Once registered, the UI reflow extension can determine the width of each registered component state and the width of each registered UI configuration. In a more general sense, the registration of the UI configurations effectively serves to include or add the component states and the UI configurations created by the UI designer to the UI reflow extension, for example, to the internal list of configurations of the UI reflow extension, for use in rendering the UI.

For example, the width of each registered UI configuration can be determined as the sum of the widths of the component states specified for the specific registered UI configuration. In some embodiments, the UI reflow extension may delegate the determination (e.g., measuring) of the respective widths of the registered component states and/or the registered UI configurations to a separate entity or process. When the UI agent application performs a refresh of the display of the UI and prior to the display of the UI being refreshed, the UI reflow extension identifies the widest registered UI configuration that best fits within the display container (e.g., the best fitting registered UI configuration), and causes the refresh of the display of the UI to occur with the identified widest registered UI configuration that best fits within the display container. That is, the result of the refresh of the display of the UI is a display of the identified widest registered UI configuration that best fits within the display container. So, for instance, if there are three registered UI configurations include A (least wide), B (intermediate width), and C (widest), and configurations A and B both fit within the display container but configuration C is too wide to fit into the container, then configuration B is identified as the widest registered UI configuration that best fits within the display container. As will be further appreciated, reference to “best” here simply means the widest available registered UI configuration that fits within the display container but isn't wider than the display container. So, for instance, if there are three registered UI configurations include A (500 pixels wide), B (600 pixels wide), and C (700 pixels wide), and the display container is 650 pixels wide, then configuration B is identified as the widest registered UI configuration that best fits within the display container. In a more general sense, to identify a best fit includes determining respective widths for each registered UI configuration, identifying the registered UI configuration or configurations whose respective widths are not wider than a width of a display container, and selecting the widest registered UI configuration from the identified registered UI configurations as a widest registered UI configuration that best fits within the display container. That is, the widest registered UI configuration that best fits within the display container is the registered UI configuration which has a width closer to the width of the display container without exceeding the width of the display container. To this end, the determination of the best fitting widest UI configuration can be carried out using, for example, conditional logic or a comparator module, as will be appreciated.

In some embodiments, the UI reflow extension can modify the UI, for example, the UI code that specifies the UI, based on the identified widest registered UI configuration that best fits within the display container, thus causing the refresh of the display of the UI to occur with the identified widest registered UI configuration that best fits within the display container. In other embodiments, the UI reflow extension can indicate to or otherwise inform the UI agent application of the identified widest registered UI configuration that best fits within the display container, and the UI agent application can then perform the refresh of the display of the UI with the identified widest registered UI configuration that best fits within the display container. As will be appreciated in light of this disclosure, the UI reflow extension can utilize other communication techniques to cause the refresh of the display of the UI to occur with the identified widest registered UI configuration that best fits within the display container.

In some instances, the UI agent application may perform a refresh of the display of the UI as a result of a resizing of the display container. Depending on the width of the resized display container and the respective widths of each registered UI configuration, the widest registered UI configuration identified by the UI reflow extension may be the registered UI configuration that is being currently displayed in the display container. That is, the resizing of the display container may not cause a switch from one registered UI configuration (e.g., current registered UI configuration being displayed) to another registered UI configuration. A switch from a current registered UI configuration to another registered UI configuration occurs when the current registered UI configuration no longer fits in the resized display container. It will be appreciated in light of this disclosure that the smallest (least wide) UI configuration is an exception in that a registered UI configuration that is less wide (narrower) is not available for displaying in the resized display container.

In some embodiments, the UI reflow extension may be provided as part of a UI agent application. For example, the functionality provided by the UI reflow extension may be integrated into the UI agent application. In other embodiments, the UI reflow extension may be provided as a distinct process that executes in conjunction with a UI agent application. In these embodiments, the UI reflow extension need not be included as part of a UI, for example, by a UI designer.

Although certain embodiments and/or examples are described below in the context of a UI being a webpage, it will be appreciated in light of this disclosure that such embodiments and/or examples are not restricted to webpages but are applicable to UIs in the general sense.

Framework

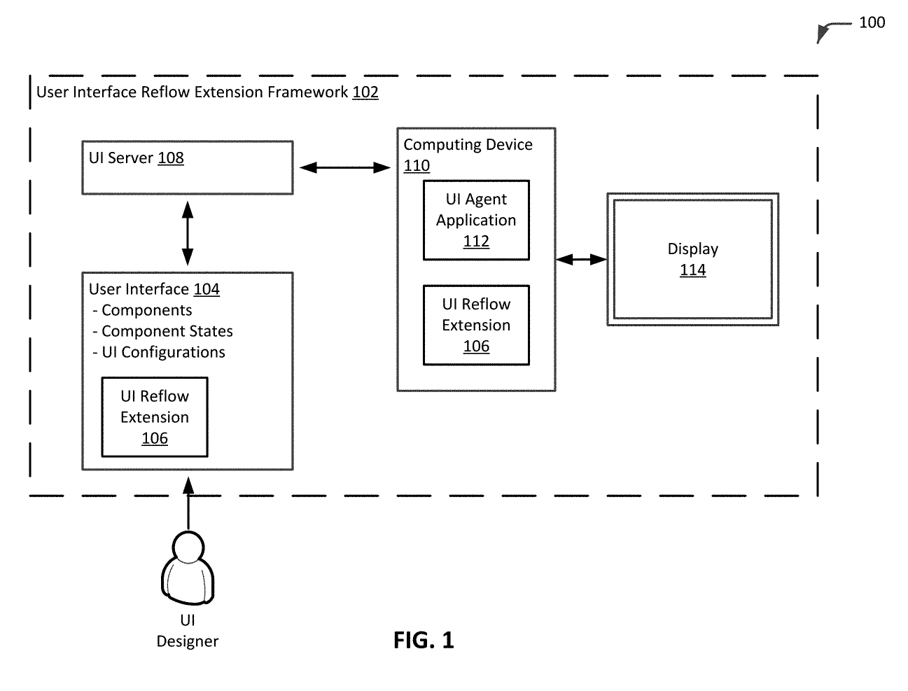

Turning now to the figures, FIG. 1 is a diagram 100 illustrating an example user interface (UI) reflow extension framework 102, in accordance with at least some embodiments described herein. UI reflow extension framework 102 facilitates creation of UIs whose components switch states to a state that best fits within a display container without overflowing or changing to unexpected visual states as the display container resizes. As discussed above, a resizing of the display container may result in a reflow of a UI, which may cause the components, including the elements of the components, of the UI to overflow or change to an unexpected visible state. In some embodiments, UI reflow extension framework 102 provides an extension to the conventional UI reflow process that promotes control of the reflow of the UI by a UI designer. Utilizing the UI reflow extension, a UI designer can create a UI whose components switch to states specified by the UI designer at specified breakpoints in the width of the display container, thus allowing the UI designer to control reflow of the UI. The illustrated framework is only one example of a suitable operating framework and is not intended to suggest any limitation as to the scope of use or functionality of the UI reflow extension.

As shown in diagram 100, a UI designer may use a device that facilitates the creation user interfaces, such as webpages, and create a UI 104 that includes one or more components. In creating UI 104, the UI designer can create one or more states of each component included in UI 104, and define multiple UI configurations of UI 104. For example, the UI designer can define a UI configuration by specifying the component states for the components that are included in the UI configuration. That is, the UI designer can define a specific UI configuration of a UI by specifying the states of the components that are included in the UI in that specific configuration of the UI. The UI designer can also include with UI 104 a UI reflow extension 106, which is configured to control the reflow of UI 104 as described herein. Accordingly, UI 104 includes the components and component states created by the UI designer, the UI configurations defined by the UI designer, and UI reflow extension 106. As will be appreciated, UI 104 may also include logic, code, and/or data in addition to UI reflow extension 106 and the components, component states, and UI configurations created and/or defined by the UI designer. In some embodiments, the UI designer may also specify the UI configurations of the multiple UI configurations that are to be registered for use in the rendering of the UI. Registration of UI configurations allows the UI designer to define UI configurations that may not be initially registered for use in rendering of the UI, but can readily be registered and utilized at a subsequent point in time.

Once created, UI 104 may be provided to a UI server 108 for delivery to computing devices, such as a computing device 110. For example, a user of computing device 110 may execute a UI agent application 112 to initiate communication with UI server 108 and request UI 104. In response to the request, UI server 108 can provide UI 104 to UI agent application 112 executing on computing device 108. UI agent application 112 can then render a default configuration of UI 104 on a display 114 operatively coupled to computing device 108. In some instances, the default configuration may be specified by UI server 110. Additionally or alternatively, the UI designer may specify a default configuration at the time of creating UI 104. Contemporaneous with the initial rendering of UI 104, UI reflow extension 106 included in UI 104 can start executing on computing device 110. In some embodiments, UI reflow extension 106 may start executing on computing device 110 prior to the initial rendering of UI 104. For example, UI reflow extension 106 may start executing on computing device 110 upon receipt of UI 104 by UI agent application 112. In other embodiments, UI reflow extension 106 may be provided as part of (e.g., integrated into) UI agent application 112.

In some embodiments, UI reflow extension 106 is configured to process the registration of the component states and the UI configurations of UI 104, for example, as specified by the designer of UI 104. UI reflow extension 106 is also configured to determine the width of each registered component state, and the width of each registered UI configuration. For example, UI reflow extension 106 can determine a width of each registered UI configuration to be the sum of the widths of the component states specified for the registered UI configuration. In some embodiments, UI reflow extension 106 is configured to delegate the determination (e.g., measuring) of the widths of the registered component states and/or the registered UI configurations to a separate entity or process. UI reflow extension 106 is also configured to hook into a UI display refresh process of UI agent application 112. For example, UI agent application 112 may provide a mechanism for processes, such as UI reflow extension 106, to listen for specific events, such as a display ready event that signals a rendering of a UI, and a UI refresh event that signals a refreshing of a display of a UI, to name a few examples, generated by UI agent application 112. As will be appreciated, a UI refresh event is any event that causes a re-rendering of a given display, such as a user-initiated resizing of a display window or browser, or an application-initiated resizing of a display window or browser. Further recall, however, that a switch from a current registered UI configuration to another registered UI configuration occurs when the current registered UI configuration no longer fits in the resized display container, and a given resizing event may not cause such non-fit condition. In any such cases, UI reflow extension 106 can utilize an appropriate event generated by UI agent application 112 to hook into the display refresh processing of UI agent application 112. For example, UI reflow extension 106 can hook into UI agent application 112 to be triggered to execute as part of each refreshing of the display of UI 104 performed by UI agent application 112. UI reflow extension 106 is configured to, as part of the refreshing of the display of UI 104, identify a widest registered UI configuration of UI 104 that best fits within a display container that is displaying UI 104. UI reflow extension 106 is further configured to cause the refresh of the display of UI 104 to be conducted with the identified widest registered UI configuration of UI 104 that best fits within a display container.

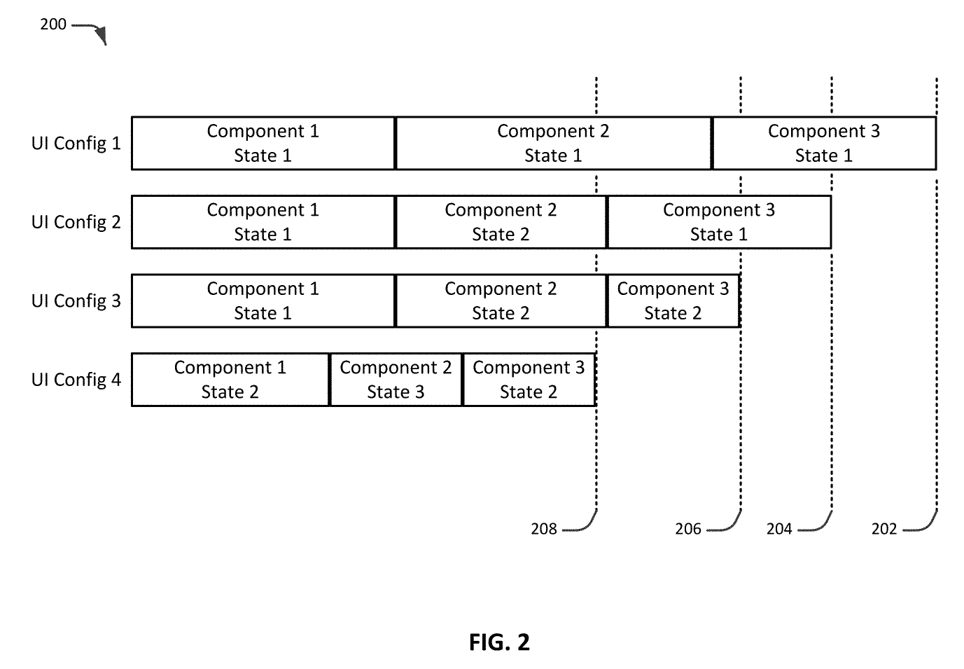

FIG. 2 is a diagram 200 illustrating multiple configurations of an example UI specified by component states included in each configuration of the UI, in accordance with at least some embodiments described herein. In some example cases and as shown in diagram 200, a UI designer may have created the UI by creating the various states of the components that may be included in the UI, and defined multiple configurations of the UI by specifying the states of the components that are included in each configuration of the UI. Four configurations of the UI, a UI Config 1, a UI Config 2, a UI Config 3, and a UI Config 4, may have been created for a UI that includes three components, a Component 1, a Component 2, and a Component 3. Specifically, UI Config 1 of the UI may have been defined as including a State 1 of Component 1 (Component 1 State 1), a State 1 of Component 2 (Component 2 State 1), and a State 1 of Component 3 (Component 3 State 1); UI Config 2 of the UI may have been defined as including State 1 of Component 1 (Component 1 State 1), a State 2 of Component 2 (Component 2 State 2), and State 1 of Component 3 (Component 3 State 1); UI Config 3 of the UI may have been defined as including State 1 of Component 1 (Component 1 State 1), State 2 of Component 2 (Component 2 State 2), and a State 2 of Component 3 (Component 3 State 2); and UI Config 4 of the UI may have been defined as including a State 2 of Component 1 (Component 1 State 2), a State 3 of Component 2 (Component 2 State 3), and State 2 of Component 3 (Component 3 State 2). In some embodiments, the four configurations of the UI, UI Config 1, UI Config 2, UI Config 3, and UI Config 4, may have been registered for use in rendering of the UI.

With reference to the UI illustrated in diagram 200, the component states may be created using the following example pseudocode:

Component1_State1=ReflowExtension.generateAndMeasureState(Component1, switchComp1ToState1Fn)
Component1_State2=ReflowExtension.generateAndMeasureState(Component1, switchComp1ToState2Fn)
Component2_State1=ReflowExtension.generateAndMeasureState(Component2, switchComp2ToState1Fn)
Component2_State2=ReflowExtension.generateAndMeasureState(Component2, switchComp2ToState2Fn)
Component2_State3=ReflowExtension.generateAndMeasureState(Component2, switchComp2ToState3Fn)
Component3_State1=ReflowExtension.generateAndMeasureState(Component3, switchComp3ToState1Fn)
Component3_State2=ReflowExtension.generateAndMeasureState(Component3, switchComp3ToState2Fn)

where the process “generateAndMeasureState” creates (generates) the indicated state for the specified component. This process may also involve measuring the specified component state, and storing the measurement, for example, for subsequent use.

With continued reference to the UI illustrated in diagram 200, the UI configurations may be registered using the following example pseudocode:

ReflowExtension.registerConfiguration([Component1_State1,
Component2_State1, Component3_State1])
ReflowExtension.registerConfiguration([Component1_State1,
Component2_State2, Component3_State1])
ReflowExtension.registerConfiguration([Component1_State1,
Component2_State2, Component3_State2])
ReflowExtension.registerConfiguration([Component1_State2,
Component2_State3, Component3_State2])

where the process “registerConfiguration” registers the indicated UI configuration with the array of component states specified for each indicated UI configuration. This process may also determine a total width of each indicated UI configuration based on the widths of the component states specified for each UI configuration.

For the example UI illustrated in diagram 200, a width of UI Config 1 (e.g., the sum of the respective widths of Component 1 State 1, Component 2 State 1, and Component 3 State 1) may have been determined to be 3,000 pixels as indicated by a breakpoint 202, a width of UI Config 2 (e.g., the sum of the respective widths of Component 1 State 1, Component 2 State 2, and Component 3 State 1) may have been determined to be 2,600 pixels as indicated by a breakpoint 204, a width of UI Config 3 (e.g., the sum of the respective widths of Component 1 State 1, Component 2 State 2, and Component 3 State 2) may have been determined to be 2,300 pixels as indicated by a breakpoint 206, and a width of UI Config 4 (e.g., the sum of the respective widths of Component 1 State 2, Component 2 State 3, and Component 3 State 2) may have been determined to be 1,700 pixels as indicated by a breakpoint 208. Based on the widths determined for each configuration of the UI, UI Config 1 of the UI is displayed in instances where a display container that is displaying the UI is of a width that is at least breakpoint 202. That is, when the width of the display container is 3,000 pixels or more, although UI Config 2, UI Config 3, and UI Config 4 also fit within the display container, UI Config 1 is the widest configuration of the UI that best fits within the display container and, accordingly, is displayed in the display container. Similarly, UI Config 2 of the UI is displayed in instances where the display container that is displaying the UI is of a width that is between breakpoint 204 and breakpoint 202. That is, when the width of the display container is between 2,600 and 3,000 pixels, although UI Config 3 and UI Config 4 also fit within the display container, UI Config 2 is the widest configuration of the UI that best fits within the display container and, accordingly, is displayed in the display container. Similarly, UI Config 3 of the UI is displayed in instances where the display container that is displaying the UI is of a width that is between breakpoint 206 and breakpoint 204. That is, when the width of the display container is between 2,300 and 2,600 pixels, although UI Config 4 also fits within the display container, UI Config 3 is the widest configuration of the UI that best fits within the display container and, accordingly, is displayed in the display container. Similarly, UI Config 4 of the UI is displayed in instances where the display container that is displaying the UI is of a width that is between breakpoint 208 and breakpoint 206. That is, when the width of the display container is between 1,700 and 2,300 pixels, as none of the other configurations of the UI fit within the display container other than UI Config 4, UI Config 4 is the widest configuration of the UI that best fits within the display container and, accordingly, is displayed in the display container. Finally, in instances where the display container that is displaying the UI is of a width that is smaller than breakpoint 208, as none of the configurations of the UI fit within the display container, UI Config 4, as a consequence of being the configuration of the UI of the least width, is considered to be the widest configuration of the UI that best fits within the display container. As such, UI Config 4 is displayed in instances where the width of the display container is of a width that is smaller than 1,700 pixels.

With continued reference to the UI illustrated in diagram 200, a widest configuration of the UI that best fits within a display container may be displayed using the following example pseudocode:

// Update with the current display container size
ReflowExtension.updateWithWidth(ApplicationWindow.width)
// Register the automatic update on window resize
Applicationwindow.on(“resize”, function(width) {

// This will update for each resize
ReflowExtension.updateWithWidth(width);

});

where the process “updateWithWidth” updates the display container with the widest configuration of the UI that best fits within the of the display container given the width of the display container. For example, when the widest configuration of the UI that best fits within the display container is determined, the UI reflow extension calls (e.g., executes) the UI configuration code provided by the UI developer, which in turn causes the components of the UI to switch to the component states specified by the determined UI configuration.

It will be appreciated in light of this disclosure that a UI can include a different number of components than that illustrated by the example UI of FIG. 2. For example, a UI may include a small number of components (for example, one or two components), or a larger number of components (for example, four, five, or more components). In addition, a smaller number of component states or a larger number of component states can be created for some or all of the components than that illustrated by the example UI of FIG. 2. In a more general sense, a UI may be created that includes any number of components, and any number of states may be created for the components that may be included in the UI. Moreover, multiple configurations of the UI may be defined by specifying a specific state created for each of the components included in each configuration of the UI.

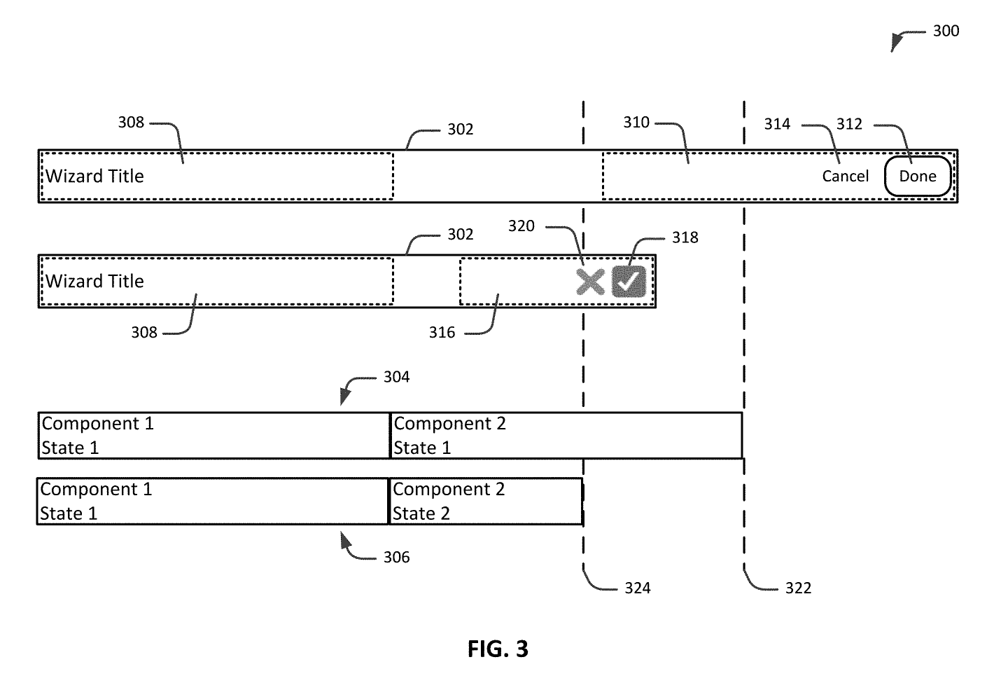

FIG. 3 is a diagram 300 illustrating two example UI configurations and corresponding rendering of the UI configurations, in accordance with at least some embodiments described herein. In some example cases and as shown in diagram 300, a UI designer may have created a UI that includes two components that are displayed in a display container 302, and defined two configurations of the UI, a UI configuration 304 and a UI configuration 306. As shown in diagram 300, display container 302 may be a task bar. UI configuration 304 may have been defined as including a State 1 of a Component 1 (Component 1 State 1) and a State 1 of a Component 2 (Component 2 State 1); and UI configuration 306 may have been defined as including the State 1 of Component 1 (Component 1 State 1) and a State 2 of Component 2 (Component 2 State 2). Component 1 State 1 may be a title bar 308 that displays a name (“Wizard Title”), Component 2 State 1 may be a task bar 310 that includes a “Done” button 312 and a “Cancel” quiet button 314, and Component 2 State 2 may be a task bar 316 that includes an icon button 318 and a quiet icon button 320. In some example cases, task bar 316 (Component 2 State 2) may be a condensed version (or state) of task bar 310 (Component 2 State 1).

UI configuration 304 of the UI is displayed in instances where display container 302 is of a width of at least breakpoint 322 or larger, and UI configuration 306 is displayed in instances where display container 302 is of a width smaller than breakpoint 322. By way of example and as shown in diagram 300, in instances where display container 302 is of a width of at least breakpoint 322, UI configuration 304 is displayed in display container 302. As display container 302 is resized causing the width of display container 302 to become smaller, UI configuration 304 continues to be displayed in display container 302 as long as the width of display container 302 is at least breakpoint 322. Once the width of display container 302 becomes smaller than breakpoint 322 (e.g., once the width of display container 302 crosses breakpoint 322 from being a larger width), UI configuration 306 is displayed in display container 302. That is, upon the width of display container 302 becoming smaller than breakpoint 322, the display of the UI in display container 302 switches from UI configuration 304 to UI configuration 306. UI configuration 306 continues to be displayed in display container 302 as long as the width of display container 302 is smaller than breakpoint 322. Once the width of display container 302 becomes larger than breakpoint 322 (e.g., once the width of display container 302 crosses breakpoint 322 from being a smaller width), UI configuration 304 is displayed in display container 302. That is, upon the width of display container 302 becoming larger than breakpoint 322, the display of the UI in display container 302 switches from UI configuration 306 to UI configuration 304.

In instances where the width of display container 302 is of a width larger than breakpoint 322 and displaying UI configuration 304, title bar 308 or task bar 310 may be repositioned (e.g., reflowed) within display container 302. The repositioning of title bar 308 or task bar 310 does not result in an overflow of title bar 308 or task bar 310, nor causes title bar 308 or task bar 310 to change visible states, since the width of display container 302 is of a width that is at least breakpoint 322. Similarly, in instances where the width of display container 302 is of a width between breakpoint 324 and breakpoint 322 and displaying UI configuration 306, title bar 308 or task bar 312 may be repositioned within display container 302. The repositioning of title bar 308 or task bar 312 does not result in an overflow of title bar 308 and task bar 312, nor causes title bar 308 or task bar 312 to change visible states, since the width of display container 302 is of a width that is at least breakpoint 324. In instances where the width of display container 302 is smaller than breakpoint 324 and displaying UI configuration 306, title bar 308 or task bar 312 may be repositioned within display container 302. The repositioning of title bar 308 or task bar 312 may result in an overflow of title bar 308 or task bar 312, or cause title bar 308 or task bar 312 to change visible states, since the width of display container 302 is not of a sufficient width to display title bar 308 and task bar 312 in their respective default (e.g., original) states.

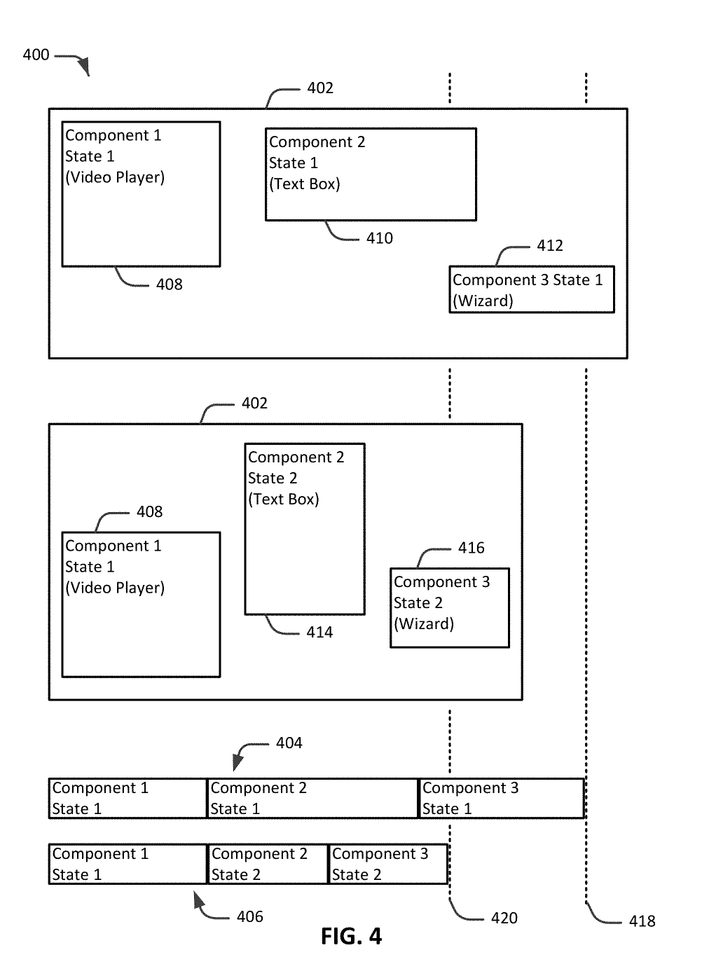

FIG. 4 is another diagram 400 illustrating two example UI configurations and corresponding rendering of the UI configurations, in accordance with at least some embodiments described herein. In some example cases and as shown in diagram 400, a UI designer may have created a UI that includes three components that are displayed in a display container 402, and defined two configurations of the UI, a UI configuration 404 and a UI configuration 406. As shown in diagram 400, display container 402 may be a display window, such as a viewport. UI configuration 404 may have been defined as including a State 1 of a Component 1 (Component 1 State 1), a State 1 of a Component 2 (Component 2 State 1), and a State 1 of a Component 3 (Component 3 State 1); and UI configuration 406 may have been defined as including State 1 of Component 1 (Component 1 State 1), a State 2 of Component 2 (Component 2 State 2), and a State 2 of Component 3 (Component 3 State 2). Component 1 State 1 may be a video player 408 that displays a playing of a video (e.g., a streaming video), Component 2 State 1 may be a text box 410 that displays text, Component 3 State 1 may be a wizard 412 (e.g., an installation wizard), Component 2 State 2 may be text box 414 that displays text, and Component 3 State 2 may be a wizard 416 (e.g., a step list wizard). In some example cases, text box 414 (Component 2 State 2) may be a condensed version (or state) of text box 410 (Component 2 State 1), and wizard 416 (Component 3 State 2) may be a condensed version of wizard 412 (Component 3 State 1).

UI configuration 404 of the UI is displayed in instances where display container 402 is of a width of at least breakpoint 418 or larger, and UI configuration 406 is displayed in instances where display container 402 is of a width smaller than breakpoint 418. By way of example and as shown in diagram 400, in instances where display container 402 is of a width of at least breakpoint 418, UI configuration 404 is displayed in display container 402. As display container 402 is resized causing the width of display container 402 to become smaller, UI configuration 404 continues to be displayed in display container 402 as long as the width of display container 402 is at least breakpoint 418. Once the width of display container 402 becomes smaller than breakpoint 418 (e.g., once the width of display container 402 crosses breakpoint 418 from being a larger width), UI configuration 406 is displayed in display container 402. That is, upon the width of display container 402 becoming smaller than breakpoint 418, the display of the UI in display container 402 switches from UI configuration 404 to UI configuration 406. UI configuration 406 continues to be displayed in display container 402 as long as the width of display container 402 is smaller than breakpoint 418. Once the width of display container 402 becomes larger than breakpoint 418 (e.g., once the width of display container 402 crosses breakpoint 418 from being a smaller width), UI configuration 404 is displayed in display container 402. That is, upon the width of display container 402 becoming larger than breakpoint 418, the display of the UI in display container 402 switches from UI configuration 406 to UI configuration 404.

In instances where the width of display container 402 is of a width larger than breakpoint 418 and displaying UI configuration 404, video player 408, text box 410, or wizard 412 may be repositioned within display container 402. The repositioning of video player 408, text box 410, or wizard 412 does not result in an overflow of video player 408, text box 410, or wizard 412, nor causes video player 408, text box 410, or wizard 412 to change visible states, since the width of display container 402 is of a width that is at least breakpoint 418. Similarly, in instances where the width of display container 402 is of a width between breakpoint 420 and breakpoint 418 and displaying UI configuration 406, video player 408, text box 414, or wizard 416 may be repositioned within display container 402. The repositioning of video player 408, text box 414, or wizard 416 does not result in an overflow of video player 408, text box 414, or wizard 416, nor causes video player 408, text box 414, or wizard 416 to change visible states, since the width of display container 402 is of a width that is at least breakpoint 420. In instances where the width of display container 402 is smaller than breakpoint 420 and displaying UI configuration 406, video player 408, text box 414, or wizard 416 may be repositioned within display container 402. The repositioning of video player 408, text box 414, or wizard 416 may result in an overflow of video player 408, text box 414, or wizard 416, or cause video player 408, text box 414, or wizard 416 to change visible states, since the width of display container 402 is not of a sufficient width to display video player 408, text box 414, and wizard 416 in their respective default (e.g., original) states.

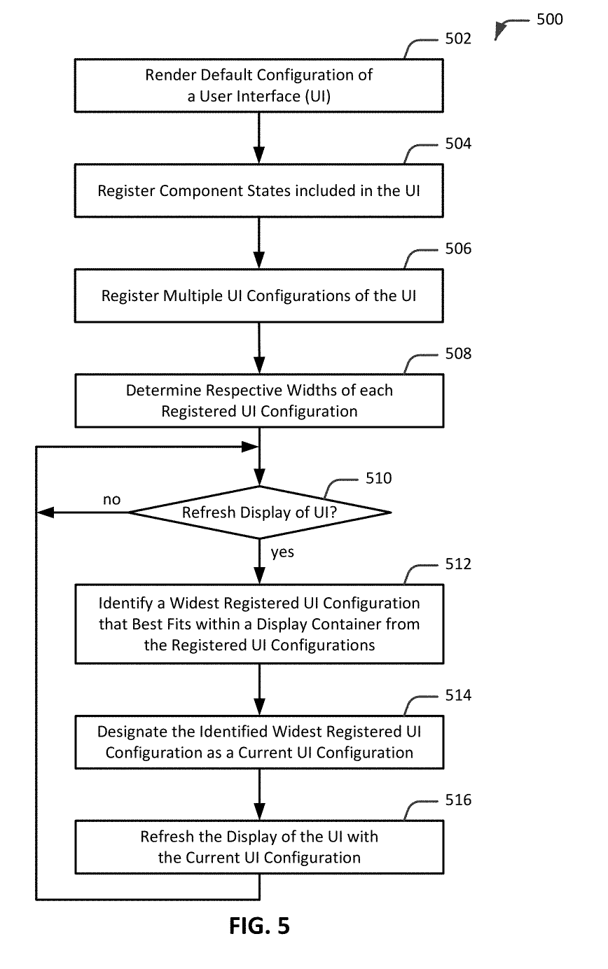

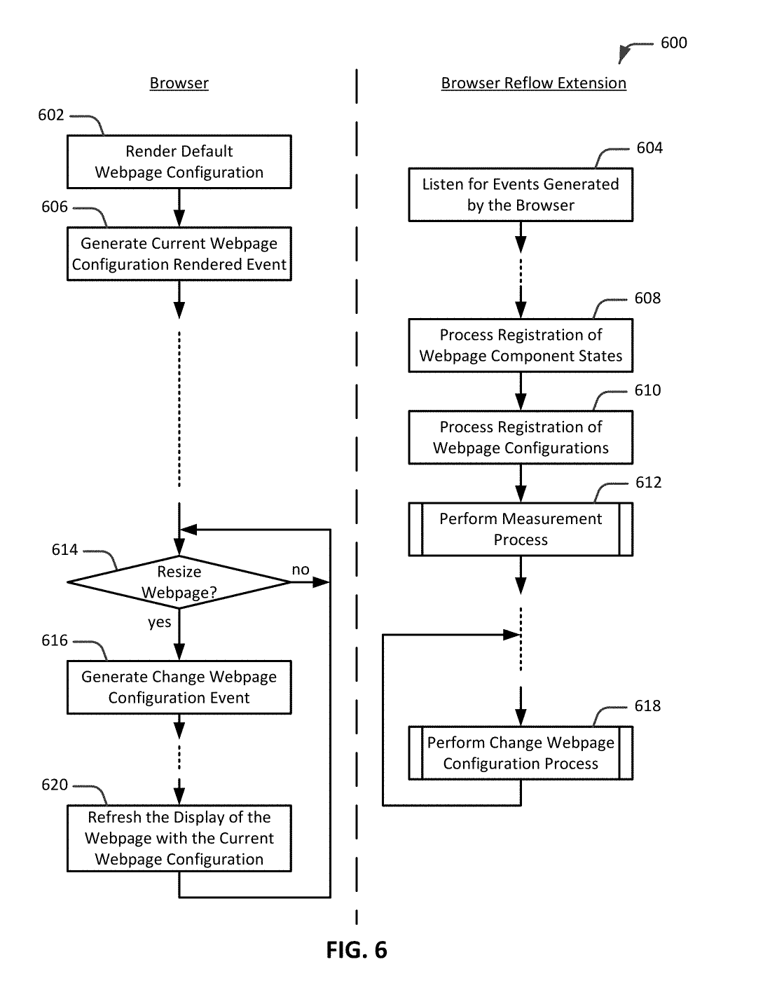

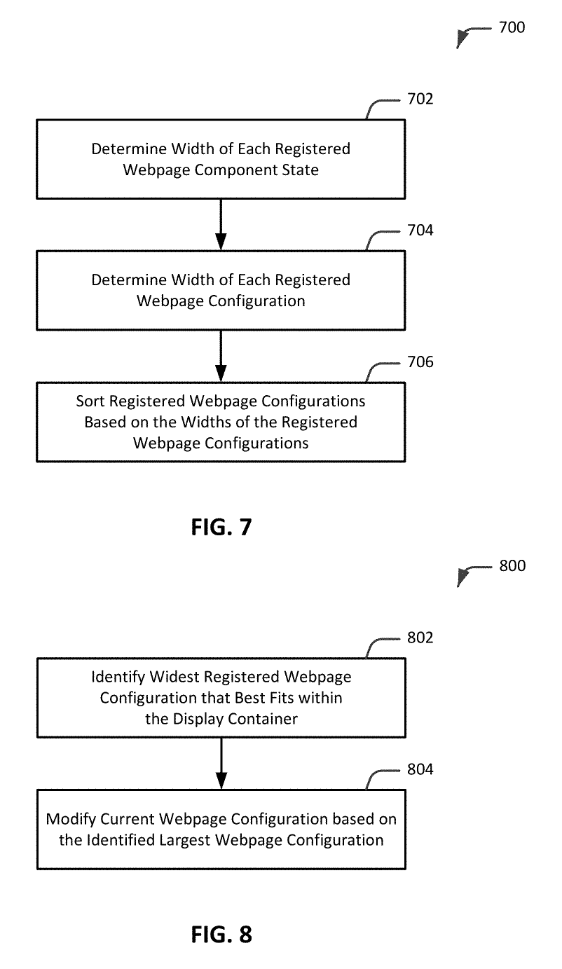

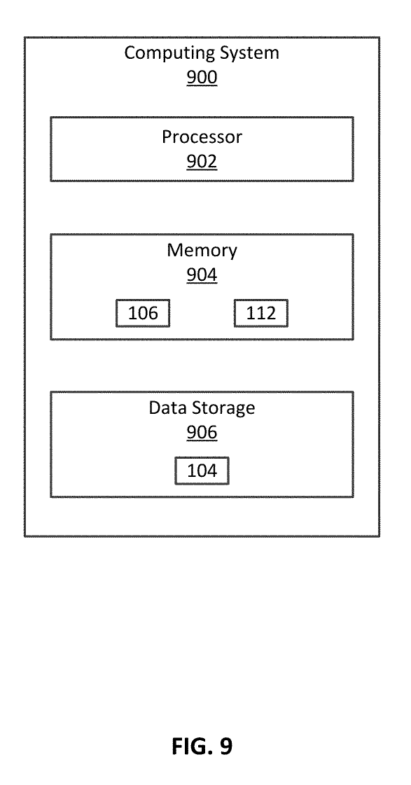

FIG. 5 is a flow diagram 500 illustrating an example process to render and refresh a UI, in accordance with at least some embodiments described herein. FIG. 6 is a flow diagram 600 illustrating an example process to render and refresh a webpage, in accordance with at least some embodiments described herein. FIG. 7 is a flow diagram 700 illustrating an example process to determine widths of registered webpage configurations, in accordance with at least some embodiments described herein. FIG. 8 is a flow diagram 800 illustrating an example process to perform a change webpage configuration, in accordance with at least some embodiments described herein. The operations, functions, or actions illustrated in the example processes of flow diagrams 500, 600, 700, and 800 may in some embodiments be performed by a computing system such as a computing system 900 of FIG. 9. The operations, functions, or actions described in the respective blocks of the example processes of flow diagrams 500, 600, 700, and 800 may also be stored as computer-executable instructions in a computer-readable medium, such as a memory 904 and/or a data storage 906 of computing system 900. The processes may be performed by components of UI reflow extension framework 102 and, in particular, computing device 108.

As will be further appreciated in light of this disclosure, for this and other processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

With reference to FIG. 5, a UI agent application that includes the UI reflow extension may render and refresh a UI. As depicted by flow diagram 500, the process may begin with block 502, where the UI agent application renders a default configuration of a UI. By way of an example use case, a user may be executing the UI agent application on a computing device, and may use the UI agent application to request the UI. The UI may include one or more component states and multiple UI configurations. That is, the UI may have been created to include one or more states of each component included in the UI and multiple configurations of the UI. In response, the UI agent application may have obtained, for example, downloaded, the requested UI from a content server, and rendered the default configuration of the requested UI, for example, on a display operatively coupled to the computing device.

Block 502 may be followed by block 504, where the UI agent application registers the states of the components that are provided with the UI. Continuing the example, the developer of the UI may have created multiple states for some or all of the components that may be included in the UI, and specified the states of the components that are to be registered for use in rendering of the UI.

Block 504 may be followed by block 506, where the UI agent application registers the multiple configurations of the UI. Continuing the example, the developer of the UI may have defined multiple configurations of the UI, and specified the configurations of the UI that are to be registered for use in rendering of the UI.

Block 506 may be followed by block 508, where the UI agent application determines the respective widths of each registered UI configuration. Continuing the example, the UI agent application can measure the width of each registered state of each component and, using the measured widths, determine the respective width of each registered UI configuration to be the sum of the widths of the registered state of the components included in the registered UI configuration. In some embodiments, the UI agent application can delegate the determination of the respective widths of each registered UI configuration to a separate process. Delegating the determination of the respective widths of each registered UI configuration to a separate process allows the measuring process to be modified (e.g., altered, enhanced, etc.) without impacting the processing and/or performance of the UI agent application.

Block 508 may be followed by decision block 510, where the UI agent application checks to determine whether the display of the UI is to be refreshed. Continuing the example, the UI agent application may periodically refresh the display of the UI. For example, the display of the UI may be refreshed at specific time intervals based on a refresh frame rate of the UI agent application. Additionally or alternatively, the UI agent application may refresh the display of the UI upon a resizing of a display container that is displaying the UI. If the UI agent application determines that the display of the UI is not to be refreshed, decision block 510 may be followed by decision block 510. That is, in this instance, the UI agent application can continue checking to determine whether the display of the UI is to be refreshed. It will be appreciated that the UI agent application can perform other processing while continuing to check to determine whether the display of the UI is to be refreshed.

Otherwise, if, at decision block 510, the UI agent application determines that the display of the UI is to be refreshed, decision block 510 may be followed by block 512, where the UI agent application identifies a widest registered UI configuration from the registered UI configurations that best fits within the display container.

Block 512 may be followed by block 514, where the UI agent application designates the identified widest registered UI configuration that best fits within the display window as a current UI configuration. The current UI configuration is the configuration of the UI that is to be displayed in the display container.

Block 514 may be followed by block 516, where the UI agent application refreshes the display of the UI with the current UI configuration. That is, the UI agent application refreshes the display of the UI by rendering the current UI configuration of the UI in the display container. Rendering the current UI configuration of the UI in the display container may include a reflowing of the layout of the components of the current UI configuration (e.g., the states of the components included in the current UI configuration) in the display container. Refreshing the display of the UI with a registered UI configuration that best fits the display window, and which was created by the UI designer, allows the UI designer to control the reflow of the UI.

Block 516 may be followed by decision block 510, where the UI agent application checks to determine whether the display of the UI is to be refreshed. That is, upon refreshing the display of the UI with the current UI configuration, the UI agent application can continue checking to determine whether the display of the UI (display of the current UI configuration) is to be refreshed.

In some embodiments, some of the operations of the process described above may be performed by components other than the UI agent application. For example, in some embodiments, the UI reflow extension may be provided along with the UI, and may execute on the computing device on which the UI is rendered. The UI reflow extension can listen for events generated by the UI agent application, and be triggered by the events to perform certain operations. For example, the UI reflow extension can be triggered to register the states of the components that are provided with the UI (block 504), register the multiple configurations of the UI (block 506), and/or determine the respective widths of each registered UI configuration (block 508). The UI reflow extension can also be triggered to identify a widest registered UI configuration from the registered UI configurations that best fits within the display container (block 512) and designate the identified widest registered UI configuration that best fits within the display window as a current UI configuration (block 514). In some embodiments, the UI reflow extension designates the identified widest registered UI configuration that best fits within the display window as the current UI configuration by modifying the UI (e.g., the code specifying the UI) based on the identified widest UI configuration. For example, the UI reflow extension can modify the UI code to render the identified widest UI configuration.

With reference to FIG. 6, a browser may render and refresh a webpage. As depicted by flow diagram 600, the process may begin with block 602, where the browser renders a default configuration of a webpage. By way of an example use case, a user may be executing the browser on a computing device, and may use the browser to request the webpage. The webpage may include one or more component states, multiple webpage configurations, and a browser reflow extension. That is, the webpage may have been created to include one or more states of each component included in the webpage, multiple configurations of the webpage, and the browser reflow extension. In response, the browser may have obtained, for example, downloaded, the requested webpage from a web server, and rendered the default configuration of the requested webpage, for example, on a display operatively coupled to the computing device. The default configuration of the webpage may have been specified by the web server at the time of providing the webpage.

At block 604, the browser reflow extension provided with the webpage starts executing on the client computer. Continuing the example, the browser reflow extension may start executing upon the webpage being downloaded onto the client computer. The browser reflow extension can hook into the processing of the browser by listening to specific events generated by the browser.

At block 606, the browser generates a current webpage configuration rendered event. Continuing the example, the browser may generate a DOMContentLoaded event upon rendering the default configuration of the webpage in a display container, such as a viewport of the browser (browser viewport).

At block 608, the browser reflow extension is triggered, for example, by the event generated by the browser at block 606, and the browser reflow extension processes the registration of the states of the components that may be included with the webpage. Continuing the example, the developer of the webpage may have created multiple states for some or all of the components that may be included in the webpage, and specified the states of the components that are to be registered for use in rendering of the webpage.

Block 608 may be followed by block 610, where the browser reflow extension processes the registration of the multiple configurations of the webpage. Continuing the example, the developer of the webpage may have defined multiple configurations of the webpage, and specified the configurations of the webpage that are to be registered for use in rendering of the webpage.

Block 610 may be followed by block 612, where the browser reflow extension performs a measurement process to determine the respective widths of each registered webpage configuration. Determination of the respective widths of each registered webpage configuration is further described below in the context of flow diagram 700 of FIG. 7. Upon performing the measurement process, the browser reflow extension may continue to listen for events generated by the browser.

At decision block 614, the browser checks to determine whether the display of the webpage is to be resized. Continuing the example, the browser can periodically check to determine whether the display of the webpage (the display of the default webpage configuration of the webpage) is to be resized after generating the current webpage configuration rendered event (block 606). For example, the browser may resize the display of the webpage upon a resizing of the display container that is displaying the webpage. If the browser determines that the display of the webpage is not to be resized, decision block 614 may be followed by decision block 614. That is, in this instance, the browser can continue checking to determine whether the display of the webpage is to be resized. It will be appreciated that the browser can perform other processing while continuing to check to determine whether the display of the webpage is to be resized.

Otherwise, if, at decision block 614, the browser determines that the display of the webpage is to be resized, decision block 614 may be followed by block 616, where the browser generates a change webpage configuration event. Continuing the example, the browser may generate a window resize event to signal processes listening on this event that the current webpage configuration (the webpage configuration that is being currently displayed) can be changed.

At block 618, the browser reflow extension is triggered, for example, by the event generated by the browser at block 616, and the browser reflow extension performs a change webpage configuration process to change the webpage configuration of the webpage as appropriate. The change webpage configuration process is further described below in the context of flow diagram 800 of FIG. 8. Upon performing the change webpage configuration process, the browser reflow extension may continue to listen for events (e.g., the window resize event) generated by the browser.

At block 620, the browser refreshes the display of the webpage with the current webpage configuration. That is, the browser refreshes the display of the webpage by rendering the current webpage configuration of the webpage in the display container. Rendering the current webpage configuration of the webpage in the display container may include a reflowing of the layout of the components of the current webpage configuration (e.g., the states of the components included in the current webpage configuration) in the display container.

Block 620 may be followed by decision block 614, where the browser checks to determine whether the display of the webpage is to be resized. That is, upon refreshing the display of the webpage with the current webpage configuration, the browser can continue checking to determine whether the display of the webpage (display of the current webpage configuration) is to be resized.

With reference to FIG. 7, a browser reflow extension may perform a measurement process to determine the respective widths of each registered webpage configuration. As depicted by flow diagram 700, the process may begin with block 702, where the browser reflow extension determines the respective widths of each registered state of each component (e.g., registered states of each component that may be included in the webpage). In some embodiments, the browser reflow extension can delegate the determination of the respective widths of each registered state of each component to a separate process.

Block 702 may be followed by block 704, where the browser reflow extension determines the respective widths of each registered webpage configuration. For example, the browser reflow extension may determine the respective width of each registered webpage configuration to be the sum of the widths of the registered state of the components included in the registered webpage configuration.

Block 704 may be followed by block 706, where the browser reflow extension sorts the registered webpage configurations based on the respective widths of the registered webpage configurations. For example, the registered webpage configurations may be sorted in descending order of width. Sorting the registered webpage configurations allows for efficient processing of the registered webpage configurations, for example, by the browser reflow extension.

With reference to FIG. 8, a browser reflow extension may perform a change webpage configuration process. As depicted by flow diagram 800, the process may begin with block 802, where the browser reflow extension identifies a widest registered webpage configuration from the registered webpage configurations that best fits within the display container.

Block 802 may be followed by block 804, where the browser reflow extension modifies the current webpage configuration based on the identified widest registered webpage configuration that best fits within the display container. In some embodiments, the browser reflow extension may modify (change) the definition of the current webpage configuration based on the identified widest registered webpage configuration that best fits within the display container. That is, the browser reflow extension may modify the definition of the current webpage configuration to reflect (e.g., define) the identified widest registered webpage configuration that best fits within the display container. In some example cases, the browser reflow extension may modify the Document Object Model (DOM) of the current webpage configuration based on the identified widest registered webpage configuration that best fits within the display container.

In some embodiments, additional operations may be performed. For example, in some embodiments, the browser reflow extension checks to determine whether there is a change in the width of the display container that is displaying the current webpage configuration. If the browser reflow extension determines that there is no change in the width of the display container, the browser reflow extension can conclude that a change to the current webpage configuration is not needed. That is, since there is no change to the width of the display container, the browser reflow extension can conclude that the current webpage configuration is still the best fitting webpage configuration. Otherwise, if there is a change in the width of the display container, the browser reflow extension proceeds with identifying a widest registered webpage configuration from the registered webpage configurations that best fits within the display container. Depending on the type of change in the width of the display container, the identified widest webpage configuration that best fits in the display container may be the current webpage configuration. In these instances, the browser reflow extension does not need to modify the current webpage configuration.

FIG. 9 illustrates selected components of example computing system 900 that may be used to perform any of the techniques as variously described in the present disclosure, in accordance with at least some embodiments described herein. In some embodiments, computing system 900 may be configured to implement or direct one or more operations associated with some or all of the engines, components and/or modules associated with UI reflow extension framework 102 of FIG. 1. For example, UI agent application 112, UI 104, and UI reflow extension 106, or any combination of these may be implemented in and/or using computing system 900. In one example case, for instance, each of UI agent application 112 and UI reflow extension 106 is loaded in memory 904 and executable by a processor 902, and UI 104 is included in data storage 906. Computing system 900 may be any computer system, such as a workstation, desktop computer, server, laptop, handheld computer, tablet computer (e.g., the iPad® tablet computer), mobile computing or communication device (e.g., the iPhone® mobile communication device, the Android™ mobile communication device, and the like), or other form of computing or telecommunications device that is capable of communication and that has sufficient processor power and memory capacity to perform the operations described in this disclosure. A distributed computational system may be provided that includes a multiple of such computing devices. As depicted, computing system 900 may include processor 902, memory 904, and data storage 906. Processor 902, memory 904, and data storage 906 may be communicatively coupled.

In general, processor 902 may include any suitable special-purpose or general-purpose computer, computing entity, or computing or processing device including various computer hardware, firmware, or software modules, and may be configured to execute instructions, such as program instructions, stored on any applicable computer-readable storage media. For example, processor 902 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 9, processor 902 may include any number of processors and/or processor cores configured to, individually or collectively, perform or direct performance of any number of operations described in the present disclosure. Additionally, one or more of the processors may be present on one or more different electronic devices, such as different servers.

In some embodiments, processor 902 may be configured to interpret and/or execute program instructions and/or process data stored in memory 904, data storage 906, or memory 904 and data storage 906. In some embodiments, processor 902 may fetch program instructions from data storage 906 and load the program instructions in memory 904. After the program instructions are loaded into memory 904, processor 902 may execute the program instructions.

For example, in some embodiments, any one or more of the engines, components and/or modules of UI reflow extension framework 102 may be included in data storage 906 as program instructions. Processor 902 may fetch some or all of the program instructions from data storage 906 and may load the fetched program instructions in memory 904. Subsequent to loading the program instructions into memory 904, processor 902 may execute the program instructions such that the computing system may implement the operations as directed by the instructions.

In some embodiments, virtualization may be employed in computing device 900 so that infrastructure and resources in computing device 900 may be shared dynamically. For example, a virtual machine may be provided to handle a process running on multiple processors so that the process appears to be using only one computing resource rather than multiple computing resources. Multiple virtual machines may also be used with one processor.

Memory 904 and data storage 906 may include computer-readable storage media for carrying or having computer-executable instructions or data structures stored thereon. Such computer-readable storage media may include any available media that may be accessed by a general-purpose or special-purpose computer, such as processor 902. By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause processor 902 to perform a certain operation or group of operations.

Modifications, additions, or omissions may be made to computing system 900 without departing from the scope of the present disclosure. For example, in some embodiments, computing system 900 may include any number of other components that may not be explicitly illustrated or described herein.

As indicated above, the embodiments described in the present disclosure may include the use of a special purpose or a general purpose computer (e.g., processor 902 of FIG. 9) including various computer hardware or software modules, as discussed in greater detail herein. As will be appreciated, once a general purpose computer is programmed or otherwise configured to carry out functionality according to an embodiment of the present disclosure, that general purpose computer becomes a special purpose computer. Further, as indicated above, embodiments described in the present disclosure may be implemented using computer-readable media (e.g., memory 904 of FIG. 9) for carrying or having computer-executable instructions or data structures stored thereon.

Numerous example variations and configurations will be apparent in light of this disclosure. According to some examples, computer-implemented methods to reflow a User Interface (UI) for presentation within a display container are described. An example computer-implemented method may include: rendering a UI configuration of a UI, the UI including one or more components; registering one or more component states of each component included in the UI; registering multiple UI configurations of the UI; determining a respective width of each registered UI configuration of the multiple registered UI configurations; and responsive to a UI refresh event, determining a width of the display container, identifying the registered UI configurations whose respective widths are not wider than the width of the display container, selecting a widest registered UI configuration from the identified registered UI configurations as a widest registered UI configuration that best fits within the display container, and rendering the selected widest registered UI configuration for presentation within the display container.

In some examples, the UI is a webpage, rendering the UI configuration is performed by a browser, and registering one or more component states and registering the multiple UI configurations and determining the respective width of each registered UI configuration is performed by a browser reflow extension. In other examples, the UI is a webpage, and the UI refresh event is a webpage refresh event. In still other examples, identifying the registered UI configurations whose respective widths are not wider than the width of the display container and selecting a widest registered UI configuration from the identified registered UI configurations as a widest registered UI configuration that best fits within the display container is performed by a browser reflow extension, and rendering the selected widest registered UI configuration for presentation within the display container is performed by a browser. In yet other examples, selecting a widest registered UI configuration from the identified registered UI configurations as a widest registered UI configuration that best fits within the display container includes modifying a Document Object Model (DOM). In other examples, the display container is a UI display area. In still other examples, the display container is a browser viewport.

According to some examples, systems for providing reflow of a User Interface (UI) are described. An example system may include: one or more non-transitory machine readable media configured to store instructions; and one or more processors configured to execute the instructions stored on the one or more non-transitory machine readable media. Execution of the instructions by the one or more processors may cause the one or more processors to: render a UI configuration of a UI within a display container; and, responsive to a UI refresh event, determine a width of the display container, identify, from multiple registered UI configurations, the registered UI configurations whose respective widths are not wider than the width of the display container, select a widest registered UI configuration from the identified registered UI configurations as a widest registered UI configuration that best fits within the display container, and render the selected widest registered UI configuration for presentation within the display container.

In some examples, the UI includes one or more components, and execution of the instructions by the one or more processors may cause the one or more processors to: register one or more component states of each component included in the UI; register the multiple UI configurations of the UI; and determine a respective width of each registered UI configuration of the multiple registered UI configurations. In other examples, to select a widest registered UI configuration from the identified registered UI configurations as a widest registered UI configuration that best fits within the display container includes to modify code based on the selected widest registered UI configuration. In still other examples, to modify code includes to modify a Document Object Model (DOM). In yet other examples, the refresh UI event is caused by a resize of the display container. In still further examples, to render the selected widest registered UI configuration for presentation within the display container includes to render the selected widest registered UI configuration within a resized display container. In other examples, the UI is a webpage. In still other examples, the UI refresh event is a webpage refresh event.

According to some examples, computer program products including one or more non-transitory machine readable media encoded with instructions that when executed by one or more processors cause a process to be carried out to provide reflow of a user interface (UI) are described. An example process may include: cause provisioning of a UI, the UI including executable code configured to register one or more component states of each component included in the UI, register multiple UI configurations of the UI, and determine a respective width of each registered UI configuration of the multiple registered UI configurations; cause rendering a UI configuration of the UI within a display container; and responsive to a UI refresh event, determine a width of the display container, identify, from multiple registered UI configurations, the registered UI configurations whose respective widths are not wider than the width of the display container, select a widest registered UI configuration from the identified registered UI configurations as a widest registered UI configuration that best fits within the display container, and render the selected widest registered UI configuration for presentation within the display container.

In some examples, the UI is a webpage, and the multiple UI configurations of the UI is created by a webpage designer. In other examples, select a widest registered UI configuration from the identified registered UI configurations as a widest registered UI configuration that best fits within the display container includes modify code based on the selected widest registered UI configuration. In still other examples, modify code includes modify a Document Object Model (DOM). In yet other examples, the UI refresh event is caused by a resizing of the display container.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A computer-implemented method to reflow a User Interface (UI) for presentation within a display container, the method comprising:
rendering a UI configuration of a UI, the UI including one or more components;
registering one or more component states of each component included in the UI;
registering a plurality of UI configurations of the UI;
determining a respective width of each registered UI configuration of the plurality of registered UI configurations; and
responsive to a UI refresh event
determining a width of the display container,
identifying the registered UI configurations whose respective widths are not wider than the width of the display container,
selecting a widest registered UI configuration from the identified registered UI configurations as a widest registered UI configuration that best fits within the display container, and
rendering the selected widest registered UI configuration for presentation within the display container.

2. The method of claim 1, wherein the UI is a webpage, and further wherein rendering the UI configuration is performed by a browser, and registering one or more component states and registering the plurality of UI configurations and determining the respective width of each registered UI configuration is performed by a browser reflow extension.

3. The method of claim 1, wherein the UI is a webpage, and the UI refresh event is a webpage refresh event.

4. The method of claim 3, wherein identifying the registered UI configurations whose respective widths are not wider than the width of the display container and selecting a widest registered UI configuration from the identified registered UI configurations as a widest registered UI configuration that best fits within the display container is performed by a browser reflow extension, and rendering the selected widest registered UI configuration for presentation within the display container is performed by a browser.

5. The method of claim 3, wherein selecting a widest registered UI configuration from the identified registered UI configurations as a widest registered UI configuration that best fits within the display container comprises modifying a Document Object Model (DOM).

6. The method of claim 1, wherein the display container is a UI display area.

7. The method of claim 1, wherein the display container is a browser viewport.

8. A system for providing reflow of a User Interface (UI), the system comprising:
one or more non-transitory machine readable media configured to store instructions; and
one or more processors configured to execute the instructions stored on the one or more non-transitory machine readable media, wherein execution of the instructions causes the one or more processors to
render a UI configuration of a UI within a display container, and
responsive to a UI refresh event,
determine a width of the display container,
identify, from a plurality of registered UI configurations, the registered UI configurations whose respective widths are not wider than the width of the display container,
select a widest registered UI configuration from the identified registered UI configurations as a widest registered UI configuration that best fits within the display container, and
render the selected widest registered UI configuration for presentation within the display container.

9. The system of claim 8, wherein the UI includes one or more components, and further wherein the one or more non-transitory machine readable media further stores instructions that, in response to execution by the one or more processors, cause the one or more processors to:
register one or more component states of each component included in the UI;
register the plurality of UI configurations of the UI; and
determine a respective width of each registered UI configuration of the plurality of registered UI configurations.

10. The system of claim 8, wherein to select a widest registered UI configuration from the identified registered UI configurations as a widest registered UI configuration that best fits within the display container comprises to modify code based on the selected widest registered UI configuration.

11. The system of claim 10, wherein to modify code comprises to modify a Document Object Model (DOM).

12. The system of claim 8, wherein the refresh UI event is caused by a resize of the display container.

13. The system of claim 8, wherein to render the selected widest registered UI configuration for presentation within the display container comprises to render the selected widest registered UI configuration within a resized display container.

14. The system of claim 8, wherein the UI is a webpage.

15. The system of claim 14, wherein the UI refresh event is a webpage refresh event.

16. A computer program product including one or more non-transitory machine readable media encoded with instructions that when executed by one or more processors cause a process to be carried out to provide reflow of a user interface (UI), the process comprising:
cause provisioning of a UI, the UI comprising executable code configured to
register one or more component states of each component included in the UI,
register a plurality of UI configurations of the UI, and
determine a respective width of each registered UI configuration of the plurality of registered UI configurations;
cause rendering of a UI configuration of the UI within a display container; and
responsive to a UI refresh event
determine a width of the display container,
identify, from a plurality of registered UI configurations, the registered UI configurations whose respective widths are not wider than the width of the display container,
select a widest registered UI configuration from the identified registered UI configurations as a widest registered UI configuration that best fits within the display container, and
render the selected widest registered UI configuration for presentation within the display container.

17. The computer program product of claim 16, wherein the UI is a webpage, and the plurality of UI configurations of the UI is created by a webpage designer.

18. The computer program product of claim 16, wherein select a widest registered UI configuration from the identified registered UI configurations as a widest registered UI configuration that best fits within the display container comprises modify code based on the selected widest registered UI configuration.

19. The computer program product of claim 18, wherein modify code comprises modify a Document Object Model (DOM).

20. The computer program product of claim 16, wherein the UI refresh event is caused by a resizing of the display container.
